(19) United States
(12) Patent Application Publication
(10) Pub. No.: US 2007/0204471 A1
(43) Pub. Date: Sep. 6, 2007

(54) Knife with disposable and interchangeable blade

(76) Inventor: Matthew I. Castagna, Littleton, CO (US)

Correspondence Address: Matthew I. Castagna, 13266 Saturn Drive, Littleton, CO, 80124, US

(21) Appl. No.: 11/651,759

(22) Filed: Jan. 9, 2007

Related U.S. Application Data
(60) Provisional application No. 60/778,558, filed on Mar. 2, 2006.

(51) Int. Cl. B25G 3/00

(52) U.S. Cl. 30/342

(57) ABSTRACT

A knife system including a handle and a disposable and interchangeable blade sized for kitchen, hunting, or fishing uses. The knife handle grips surround a handle core component. The handle core is shaped to hold a disposable and interchangeable knife blade. A latching arm component resides within the handle core, placing tension on the knife blade as the blade is inserted into the handle. A protrusion and a cutout on the latching arm and the blade engage each other and lock the blade in the handle. A blade release member is actuated against a release spring to force the latching arm to disengage and release the blade. The knife system has the advantages of easy removal, disposal, and replacement of dull, broken, or damaged full-sized knife blades.

### CROSS-REFERENCE TO RELATED APPLICATIONS

This application claims benefit of U.S. Provisional Application No. 60/778,558, entitled “Knife with Disposable and Interchangeable Blade” and filed on Mar. 2, 2006, which is specifically incorporated herein by reference for all that it discloses and teaches.

### TECHNICAL FIELD

The invention relates generally to cutting implements and more particularly to a knife with a disposable and interchangeable blade. A knife handle assembly and disposable and interchangeable blade function together as a knife system to perform various functions such as cutting, chopping and slicing.

### BACKGROUND

Knives have been used for centuries, from the days of the first bone and flint knives to today's high-carbon steel knives employed in modern kitchens. Over the years, many different sizes and shapes have been developed in order to meet the various demands of knife wielders. These size and shape innovations have helped to simplify many of the ordinary chores in which various knives are often used. However, one common problem still remains: regardless of the shape or size of the knife in question, the blade eventually dulls from use and needs to be resharpened in order to regain its original cutting efficiency. Depending on the shape, size, and composition of the blade, the resharpening process can be difficult and time-consuming, at best.

An examination of the plethora of sharpening methods and devices hints at the scope of the problem. People employ everything from old hand-held sharpening stones to automated electric sharpening devices, and yet the “dull blade syndrome” continues to plague the average kitchen (i.e., the standard kitchen knife is more often dull than sharp). Other special-purpose knives such as those used by sportsmen for skinning, boning, filleting and otherwise processing fish and game also dull quickly and become difficult to use until time and effort is expended resharpening them.

Three specialized knife applications are especially prone to the dull blade syndrome: kitchen knives, hunting knives, and fishing knives (i.e., fillet knives). These three knife types usually have medium to large blades with relatively thick blade spines so that each knife has the strength necessary to carry out its specialized tasks. Further, kitchen, hunting and fishing knives are often used repetitively and can dull before the user is finished with the cutting task. In a few very specialized cutting implement applications—such as surgical scalpels, razor blades, and “X-ACTO” modeling knives—blades have been developed that are designed to avoid the dull blade syndrome. These specialized cutting implements are designed to either be completely disposable (e.g., surgical scalpels) or to have an interchangeable blade component (e.g., “X-ACTO” knives). However, these small, specialized cutting implements can not function as kitchen, hunting or fishing knives because they incorporate delicate, use-specific blades that are unable to handle the rigors to which such knives are commonly subjected. Therefore, strong, durable kitchen, hunting and fishing knives are needed that avoid the dull blade syndrome.

### SUMMARY

Embodiments described and claimed herein address the foregoing problems by providing a component knife system including a handle assembly and a disposable and interchangeable blade sized for kitchen, hunting, or fishing uses. The knife system provides for the easy removal, disposal, and replacement of dull, broken, or damaged full-sized knife blades.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 illustrates a rear view perspective of an exemplary embodiment of a disposable and interchangeable blade knife system including an assembled knife and two disposable and interchangeable blades.

FIG. 2 provides a rear view exploded perspective of an exemplary embodiment of a knife system.

FIG. 3 illustrates a rear view perspective of an exemplary embodiment of a push-button blade-release knife system.

FIG. 4 illustrates a rear view perspective of an exemplary embodiment of a turn-knob blade-release knife system.

FIG. 5 illustrates a top view of an exemplary embodiment of a knife system.

FIG. 6 illustrates a rear end view of an exemplary embodiment of a knife system.

FIG. 7 illustrates a front end view of an exemplary embodiment of a knife system.

FIG. 8 illustrates a side view of an exemplary embodiment of a knife system.

### DETAILED DESCRIPTION

In one embodiment, a knife handle assembly and disposable and interchangeable blade comprise a knife system wherein a standard-sized knife can be used in the kitchen, for example, until dull. The user can then remove the dull blade, interchange it with a new, sharp blade, and simply dispose of the old blade. A significant benefit of this system is that the knife user does not need to expend any time or effort resharpening the dull blade.

In another embodiment, the interchangeable blade is smaller-sized to more closely resemble a pairing knife type blade. The corresponding knife handle assembly can be similarly reduced in size or can remain the standard size. In other embodiments of the system, various size disposable blades and handles can be utilized.

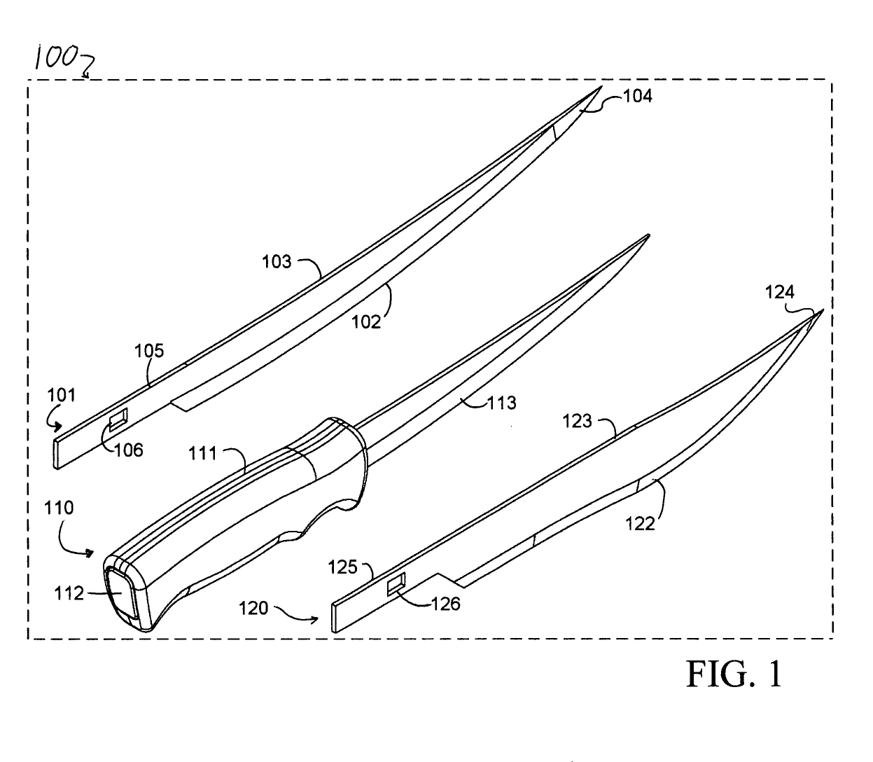

FIG. 1 illustrates an exemplary embodiment of a disposable and interchangeable blade knife system including an assembled knife and two disposable and interchangeable blades 100. The illustration shows three primary objects: an interchangeable and disposable fillet blade 101, a fully assembled knife system 110, and an interchangeable and disposable carving blade 120.

The interchangeable and disposable fillet blade 101 is an example of one type of blade size and style that can be used in the knife system. The fillet blade 101 can be constructed of steel or other metals, or any material known to the art, or yet to be developed, that is suitable for knife blades. The fillet blade 101 is shaped to have a cutting edge 102, a spine 103 opposite the cutting edge 102, a blade tip 104 at one end, and a blade shank 105 at the opposite end from the blade tip 104. In alternate embodiments, the interchangeable and disposable fillet blade 101 can have any of a myriad of different shapes, including, but not limited to: two or more sharpened cutting edges, a blunt blade tip, no blade tip, a gut-hook blade tip, etc. Variations in knife blade sizes and shapes are known in the art and alternate embodiments include any known or future variations of knife blade shape, size, construction, material, etc.

The cutting edge 102 can have straight, convex- or concave-shaped surfaces extending down from the spine 103 and terminating opposite the spine 103 where the surfaces join. Combinations of the aforementioned surface shapes are contemplated. Further, it is contemplated that the cutting edge 102 can utilize any of the various shapes, styles, and types of cutting edges known in the art. For example, the cutting edge can be thin and extremely sharp, thick and strong, serrated, etc. The spine 103 is often thicker in width than the cutting edge 102, thus imparting strength to the blade. In the embodiment shown in FIG. 1, the spine 103 is flat and un-sharpened. However, alternate embodiments are contemplated wherein the spine is sharpened into an additional cutting edge, shaped into a saw-blade configuration, etc. Similarly, the blade tip 104 can be sharp, blunt, etc.

In FIG. 1, the shank 105 of the disposable fillet blade 101 is that portion of the disposable blade opposite the tip-end that does not have a sharpened cutting edge. Instead, the shank 105 is shaped so as to provide a surface and structure to facilitate rigid attachment to a knife handle assembly 111. In the embodiment of the fillet blade 101 shown in FIG. 1, the shank 105 has a cutout 106 to facilitate rigid attachment of a knife handle assembly 111. In another embodiment, a disposable and interchangeable fillet blade 101 can have a protrusion instead of a cutout to assist in attaching the fillet blade 101 to the knife handle assembly 111. In yet another embodiment, the fillet blade 101 is shaped so as to securely attach to the handle assembly 111 without the use of a cutout or protrusion.

The assembled blade system 110 shown in FIG. 1 includes three main components: the knife handle assembly 111, the push-button blade release 112, and the disposable and interchangeable pairing blade 113. As discussed above, the blade 113 can be constructed in various sizes and shapes and in alternate embodiments can be replaced with a fillet blade 101, a carving blade 120, or any other disposable and interchangeable blade. The knife handle assembly 111 can be constructed of plastic, wood, metal, or any other suitable material. The handle assembly 111 can be plainly shaped as shown in the embodiment in FIG. 1. In an alternate embodiment, the handle assembly 111 can be ergonomically shaped with grooves for a user's fingers and thumb so as to provide a more comfortable and close fit to the user's hand. The knife system with disposable and interchangeable blades contemplates various knife handle shapes which are currently known in the art and which become known.

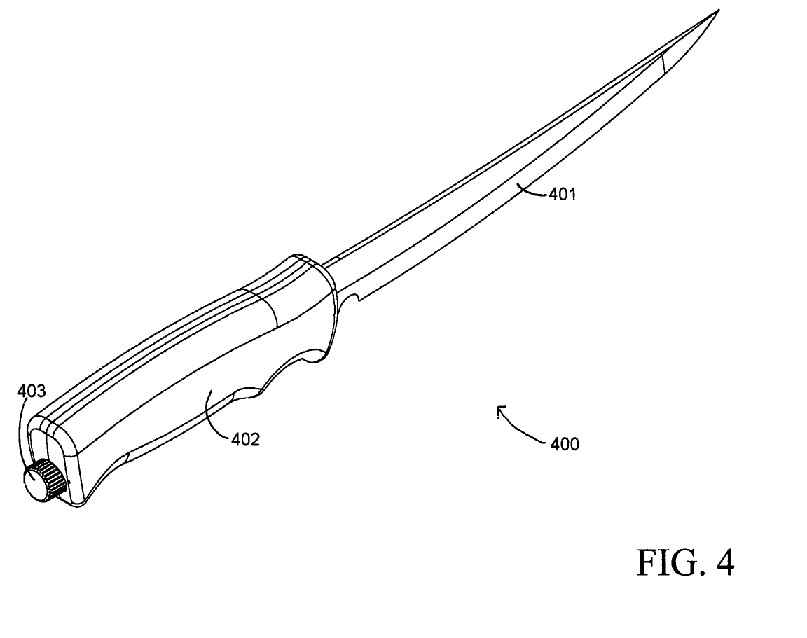

The push-button blade release 112 shown in FIG. 1 provides the blade system user with a mechanism for removing and changing knife blades. In the embodiment shown in FIG. 1, a user would utilize the following method to change blades: the user pushes in the push-button blade release 112 to release the pairing blade 113; the user removes the pairing blade 113 by pulling the blade straight out of the knife handle assembly 111, away from the push-button blade release end of the knife; the push-button blade release 112 is then released and allowed to return to its normal position; the user selects an alternate disposable and interchangeable blade, such as the carving blade 120; the alternate blade is inserted into the knife handle assembly 111; the blade automatically locks into place when fully inserted by engaging the cutout 126 within the knife handle assembly 111. In alternate embodiments, the knife system 100 can utilize other types of blade locking and release mechanisms such as the turn-knob blade release shown in FIG. 4.

The interchangeable and disposable carving blade 120 is an example of another type of blade size and style that can be used in the knife system. The carving blade 120 can be constructed of steel or other metals, or any material known to the art, or yet to be developed, that is suitable for knife blades. The carving blade 120 is shaped to have a cutting edge 122, a spine 123 opposite the cutting edge 122, a blade tip 124 at one end, and a blade shank 125 at the other end, opposite the blade tip 124. In alternate embodiments, the interchangeable and disposable carving blade 120 can have any of a myriad of different sizes and shapes, including, but not limited to: two or more sharpened cutting edges, a blunt blade tip, no blade tip, etc.

The cutting edge 122 can have a convex, straight, or concave shape. Further, it is contemplated that the cutting edge 122 can utilize any of the various shapes, styles, and types of cutting edges known in the art. For example, the cutting edge can be thin and extremely sharp, thick and strong, serrated, etc. In the embodiment shown in FIG. 1, the spine 123 is flat and un-sharpened. However, alternate embodiments are contemplated wherein the spine is sharpened into an additional cutting edge, shaped into a saw-blade configuration, etc. Similarly, the blade tip 124 can be sharp, blunt, etc.

In FIG. 1, the shank 125 of the disposable carving blade 120 is that portion of the disposable blade opposite the tip-end that does not have a sharpened cutting edge. Similar to the fillet blade shank 105, the carving blade shank 125 can have a cutout 126 to facilitate rigid attachment of a knife handle assembly 111. In another embodiment, a disposable and interchangeable carving blade 120 can have a protrusion instead of a cutout to assist in attaching the carving blade 120 to the knife handle assembly 111. In yet another embodiment, the carving blade 120 is shaped so as to securely attach to the handle assembly without the use of a cutout or protrusion.

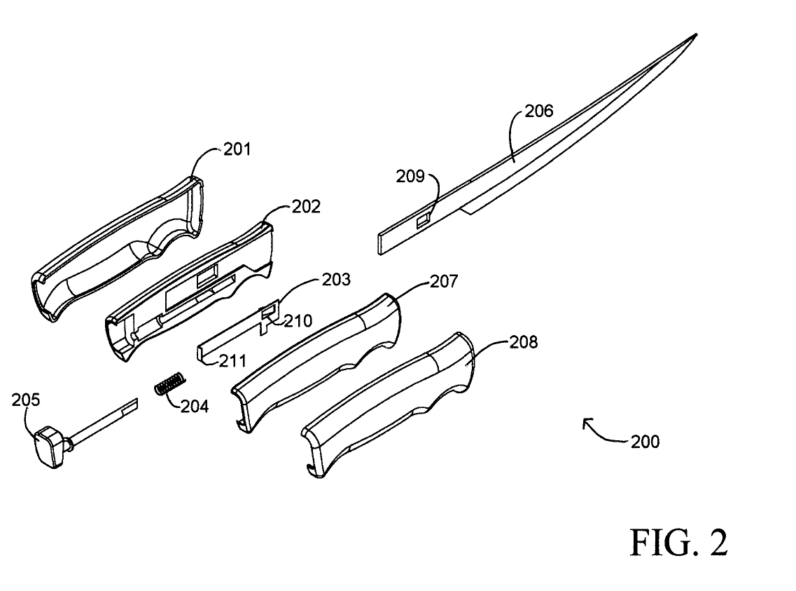

FIG. 2 provides a rear view exploded perspective of an exemplary embodiment of a knife system 200. This particular embodiment comprises the following components: left handle grip 201, left handle core 202, latching arm 203, release spring 204, blade release 205, interchangeable and disposable blade 206, right handle core 207, and right handle grip 208. In addition, the blade 206 contains a cutout 209 and the latching arm 203 has a protrusion 210 and a flange 211. The components displayed in FIG. 2 are shown from an exploded perspective. When the system is fully assembled, the left and right handle cores 202 and 207 enclose the latching arm 203, the release spring 204, the blade release 205 and the shank of the disposable blade 206. The left and right handle grips 201 and 208 fit over the handle cores 202 and 207.

In the embodiment displayed in FIG. 2, the left and right handle grips 201 and 208, respectively, are made of a soft over-molding material (e.g., rubber). In alternate embodiments, various other construction materials can be used. In yet another embodiment, the handle grips 201 and 208 can be ergonomically shaped to conform to the hand of a user of the knife. Finger grooves can be incorporated into the grips as can non-slip design elements so as to ensure that the user maintains a solid hold on the knife. Non-functional design elements such as color and stylized shapes can also be added to the handle grips.

The left and right handle cores 202 and 207, respectively, are made of injection-molded plastic or metal in the embodiment displayed in FIG. 2. Various other construction materials can be used. The handle cores are shaped so as to accept the shank of the interchangeable and disposable blade component 206 between them. The cores are further shaped so that when they are placed together, the latching arm 203, the release spring 204, and the blade release 205 (collectively, the “internal components”) fit inside and between the left and right handle core components 202 and 207. In other embodiments, inserts could be added between the handle cores and the blade 206 and/or any of the internal components to assist in maintaining the blade's rigidity and position relative to the handle cores. In yet another embodiment, the handle cores can reside inside the shank of the blade 206, i.e., the cores can be surrounded by and integrated within the shank of the blade.

The latching arm 203 is constructed of spring steel in the embodiment displayed in FIG. 2. Other construction materials can be utilized. The latching arm 203 is shaped to fit securely within the handle cores 202 and 207. As shown in the embodiment in FIG. 2, the latching arm 203 has a protrusion 210 which is shaped to fit within a matching cutout 209 in the shank of the disposable blade 206. As the blade is inserted into the assembled knife handle (see FIG. 1), the shape of the protrusion 210 on the latching arm 203 forces the latching arm 203 to flex outwards away from the shank of the disposable blade 206. When the cutout 209 in the shank of the disposable blade 206 slides into position opposite the protrusion 210 on the latching arm 203, the latching arm 203 snaps back into place with the protrusion 210 mated within the cutout 209 on the shank of the disposable blade 206, thereby securely locking the disposable blade in place. In another embodiment, the latching arm 203 can be shaped to contain a cutout and the disposable blade 206 can have a protrusion. In yet another embodiment, the protrusion and cutout are replaced with other securing features. It is also contemplated that the securing features can be incorporated into the handle cores or other components and thereby remove the latching arm component altogether.

The release spring 204 and blade release 205 function together in the embodiment pictured in FIG. 2 in order to release the disposable blade 206 from the handle assembly. The blade release 205 is shaped so as to fit inside the left and right handle cores 202 and 207. The push-button end of the blade release 205 is visible and accessible on the butt-end of the handle assembly opposite the end where the disposable blade 206 is inserted (see FIG. 1). The release spring 204 fits within the core handles and against the shaft of the blade release 205. The release spring 204 provides resistance to the in/out motion of the blade release relative to the core handles. When a user pushes the push-button end of the blade release 205, the blade release 205 is forced further into the core handles towards the point of the disposable blade 206. The release spring 204 provides resistance to this inward motion. As the blade release 205 slides deeper into the core handles, the end of the blade release 205 opposite the push-button acts against a flange 211 on the latching arm 203. The contact between the blade release 205 and the flange 211 on the latching arm 203 flexes the latching arm 203 away from the shank of the disposable blade 206. If enough pressure is applied by the user, the protrusion 210 on the latching arm 203 will disengage from the cutout 209 on the shank of the disposable blade 206, allowing the disposable blade 206 to be removed from the handle assembly. In another embodiment, the blade release 205 is shaped so that a twisting motion applied by the user to the exposed and accessible end of the blade release 205 flexes the latching arm 203 away from the shank of the disposable blade 206 and releases the disposable blade 206. In yet another embodiment, the features of the blade release 205 component are added to the handle cores such that blade release can be affected without the use of a separate and distinct blade release component.

In the embodiment shown in FIG. 2, the disposable blade 206 is shaped to have a sharpened cutting edge, a spine (opposite the cutting edge), a tip or point at one end, and a shank at the other end (opposite the point). In alternate embodiments, the disposable blade 206 can have any of a myriad of different shapes, including, but not limited to: two or more sharpened cutting edges, no point, a blunt point, a gut-hook point, etc. In FIG. 2, the shank of the disposable blade 206 is that portion of the disposable blade opposite the pointed-end that does not have a sharpened cutting edge. Instead, the shank is shaped so as to provide a surface and structure to facilitate rigid attachment between the handle cores and the disposable blade. The shank of the disposable blade 206 has a cutout 209 made to accept a protrusion 210 from the latching arm 203. In another embodiment, the disposable blade 206 has a protrusion and the latching arm 203 has a cutout. In yet another embodiment, the disposable blade 206 is shaped so as to securely attach to the handle assembly without the use of a latching arm component.

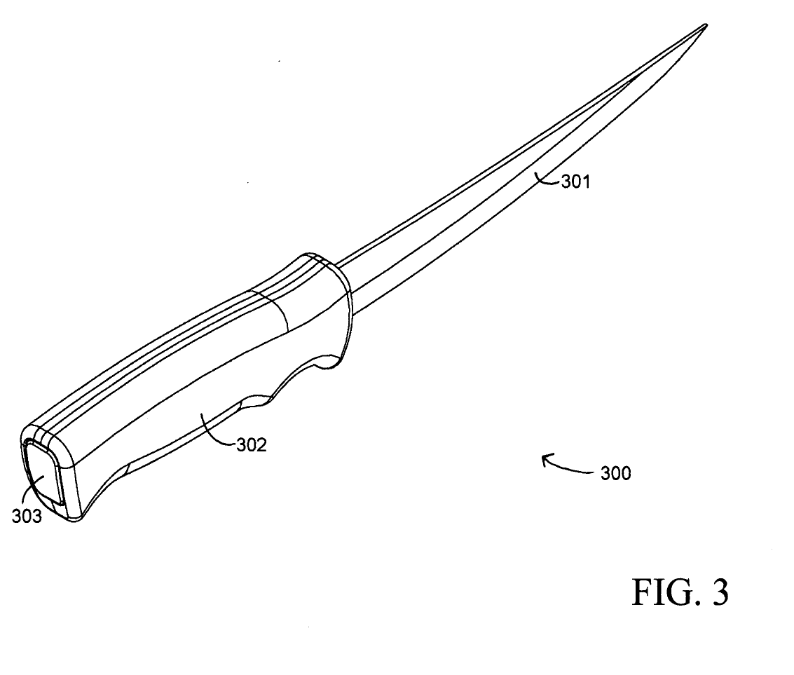

FIG. 3 illustrates a rear view perspective of an exemplary embodiment of a push-button blade-release knife system 300. The system contains two primary components: the interchangeable and disposable blade 301 and the handle assembly 302. The disposable blade 301 is inserted into one end of the handle assembly 302. At the opposite end of the handle assembly 302, the push-button end of the blade release 303 is visible. To remove the disposable blade 301, the user simply depresses the push-button end of the blade release 303 and slides the disposable blade 301 out of the handle assembly 302. As noted above, in an alternate embodiment, the push-button end of the blade release 303 could be shaped so that a twisting motion applied by the user to the exposed and accessible end of the blade release 303 releases the disposable blade 301. In such an embodiment, the push-button end of the blade release 303 can be a turn-knob (see FIG. 4) instead of a push-button. Other methods of releasing the blade are contemplated.

As a user wields the knife system to perform various tasks, the disposable blade 301 eventually dulls. The user can then employ the following method to dispose of the old blade 301 and interchange a new, sharp, disposable blade: operate the blade release 303; remove the dull blade 301; insert a new, sharp disposable blade. The user can then dispose of the old blade 301.

FIG. 4 illustrates a rear view perspective of an exemplary embodiment of a turn-knob blade-release knife system 400. The system contains two primary components: the interchangeable and disposable blade 401 and the handle assembly 402. The disposable blade 401 is inserted into one end of the handle assembly 402. At the opposite end of the handle assembly 402, the turn-knob end of the blade release 403 is visible. To remove the disposable blade 401, the user simply twists the exposed and accessible end of the blade release 403 and pulls the blade 401 away from the handle assembly 402. Other methods of releasing the blade are contemplated.

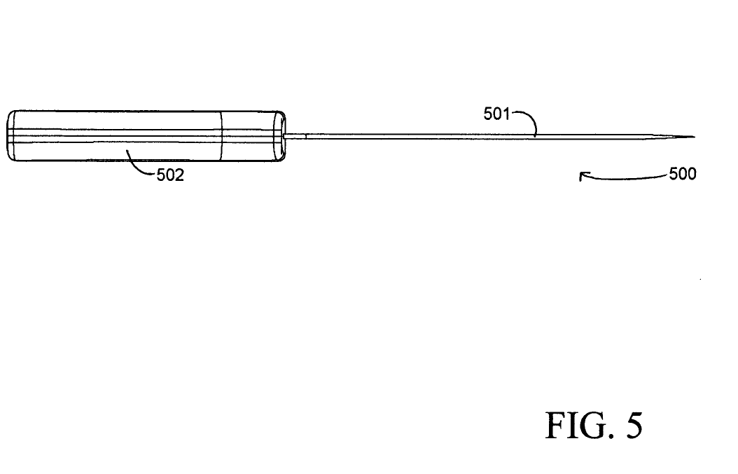

FIG. 5 illustrates a top view of an exemplary embodiment of a knife system 500. The top of the knife handle assembly 502 and the spine of the disposable blade 501 are pictured. In the embodiment shown in FIG. 5, the blade 501 is centered in the handle assembly 502. In alternate embodiments, the blade can be offset or angled. In yet another embodiment, the blade 501 can be turned ninety degrees such that it exits the handle assembly 502 between the fingers of the user forming a “T” shape with the handle assembly 502.

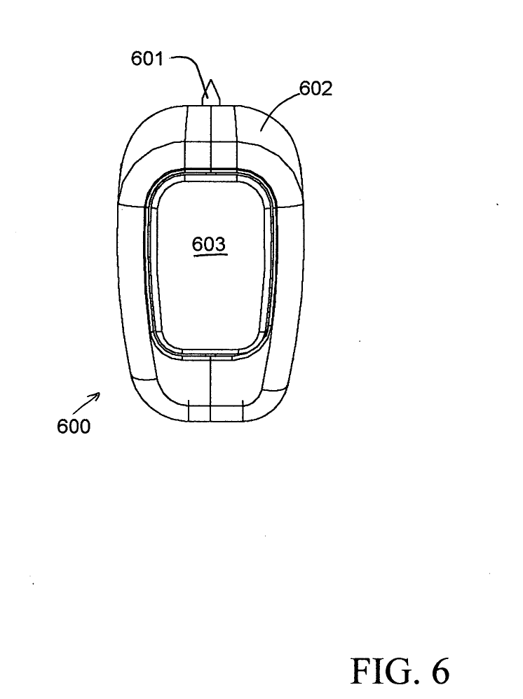

FIG. 6 illustrates a rear end view of an exemplary embodiment of a knife system 600. The blade release end of the knife system with a push-button blade release 603 is shown surrounded by the handle assembly 602. The tip of the interchangeable and disposable blade 601 can also be seen extending outwards and above the handle assembly 602.

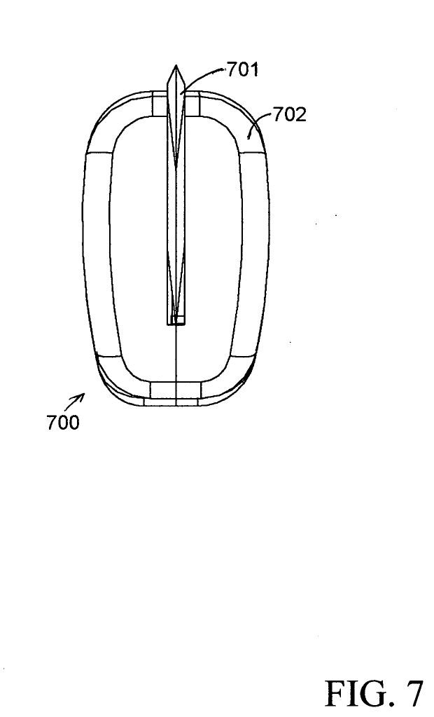

FIG. 7 illustrates a front end view of an exemplary embodiment of a knife system 700. The disposable blade tip of the knife system is shown beginning at the tip of the disposable blade 701 and looking back towards the handle assembly 702.

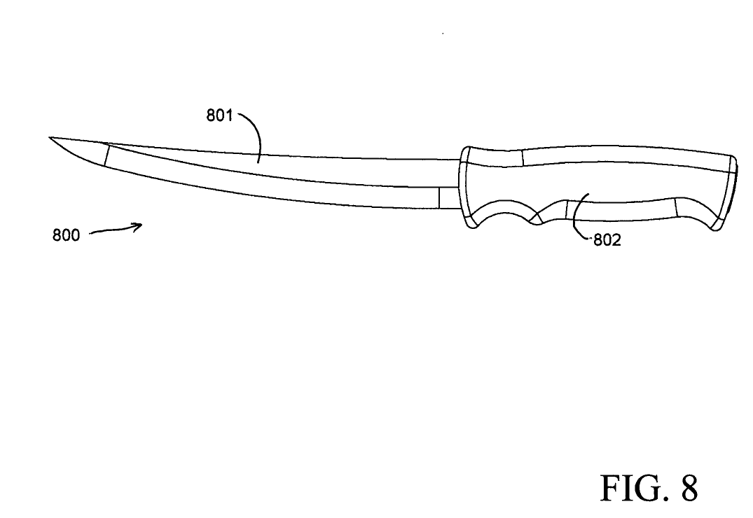

FIG. 8 illustrates a side view of an exemplary embodiment of a knife system 800. The disposable blade 801 is shown in its fully attached position inside the handle component 802.

In addition to the embodiments described above, other aspects of the present invention include methods for inserting, removing, interchanging, and disposing of the blades.

The above specification, examples and data provide a description of the structure and use of exemplary embodiments of the described articles of manufacturer and methods. Many embodiments can be made without departing from the spirit and scope of the invention.

Certain operation in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the invention.

What is claimed is:

1. A kitchen knife, comprising:
a disposable blade component having a sharpened edge and a shank;
a handle assembly having a front end and a rear end, the front end having an opening that receives the shank; and
wherein the disposable blade component is interchangeably affixed to the handle assembly.

2. A kitchen knife as claimed in claim 1, wherein the handle assembly comprises a handle grip surrounding a handle core, the handle core shaped to contain at least a latching arm and a blade release;
wherein the latching arm engages the shank to hold the disposable blade component inside the handle assembly; and
wherein the blade release acts upon the latching arm, urging the latching arm to disengage from the shank.

3. A kitchen knife as claimed in claim 2, wherein the latching arm has a protrusion and the protrusion is shaped so as to fit within a cutout on the shank.

4. A kitchen knife as claimed in claim 3, wherein the protrusion has a front edge and a rear edge, the front edge angling out from the latching arm whereby on insertion of the shank in a forward direction into the handle assembly, the latching arm bends away from the shank until the protrusion snaps into the cutout on the shank; and
wherein the rear edge of the protrusion acts against the cutout, forestalling any rearward motion of the shank.

5. A kitchen knife as claimed in claim 2, wherein the blade release comprises a push-button extending longitudinally from the rear end of the handle assembly through the handle core; and
wherein exerting inward pressure on the push-button engages the push-button and the latching arm, causing the latching arm to disengage from the shank.

6. A kitchen knife as claimed in claim 2, wherein the blade release comprises a turn-knob extending longitudinally from the rear end of the handle assembly through the handle core; and
wherein turning the turn-knob engages the turn-knob and the latching arm, causing the latching arm to disengage from the shank.

7. A kitchen knife as claimed in claim 2, wherein the latching arm has a cutout and the cutout is shaped so as to engage a protrusion on the shank.

8. A hunting knife, comprising:
a disposable blade component having a sharpened edge and a shank;
a handle assembly having a front end and a rear end, the front end having an opening that receives the shank; and
wherein the disposable blade component is interchangeably affixed to the handle assembly.

9. A hunting knife as claimed in claim 8, wherein the handle assembly comprises a handle grip surrounding a handle core, the handle core shaped to contain at least a latching arm and a blade release;
wherein the latching arm engages the shank to hold the disposable blade component inside the handle assembly; and
wherein the blade release acts upon the latching arm, urging the latching arm to disengage from the shank.

10. A hunting knife as claimed in claim 9, wherein the latching arm has a protrusion and the protrusion is shaped so as to fit within a cutout on the shank.

11. A hunting knife as claimed in claim 10, wherein the protrusion has a front edge and a rear edge, the front edge angling out from the latching arm whereby on insertion of the shank in a forward direction into the handle assembly, the latching arm bends away from the shank until the protrusion snaps into the cutout on the shank; and
wherein the rear edge of the protrusion acts against the cutout, forestalling any rearward motion of the shank.

12. A hunting knife as claimed in claim 9, wherein the blade release comprises a push-button extending longitudinally from the rear end of the handle assembly through the handle core; and
wherein exerting inward pressure on the push-button engages the push-button and the latching arm, causing the latching arm to disengage from the shank.

13. A hunting knife as claimed in claim 9, wherein the blade release comprises a turn-knob extending longitudinally from the rear end of the handle assembly through the handle core; and
wherein turning the turn-knob engages the turn-knob and the latching arm, causing the latching arm to disengage from the shank.

14. A hunting knife as claimed in claim 9, wherein the latching arm has a cutout and the cutout is shaped so as to engage a protrusion on the shank.

15. A fishing knife, comprising:
a disposable blade component having a sharpened edge and a shank;
a handle assembly having a front end and a rear end, the front end having an opening that receives the shank; and
wherein the disposable blade component is interchangeably affixed to the handle assembly.

16. A fishing knife as claimed in claim 15, wherein the handle assembly comprises a handle grip surrounding a handle core, the handle core shaped to contain at least a latching arm and a blade release;
wherein the latching arm engages the shank to hold the disposable blade component inside the handle assembly; and
wherein the blade release acts upon the latching arm, urging the latching arm to disengage from the shank.

17. A fishing knife as claimed in claim 16, wherein the latching arm has a protrusion and the protrusion is shaped so as to fit within a cutout on the shank.

18. A fishing knife as claimed in claim 17, wherein the protrusion has a front edge and a rear edge, the front edge angling out from the latching arm whereby on insertion of the shank in a forward direction into the handle assembly, the latching arm blends away from the shank until the protrusion snaps into the cutout on the shank; and
wherein the rear edge of the protrusion acts against the cutout, forestalling any rearward motion of the shank.

19. A fishing knife as claimed in claim 16, wherein the blade release comprises a push-button extending longitudinally from the rear end of the handle assembly through the handle core; and
wherein exerting inward pressure on the push-button engages the push-button and the latching arm, latching arm to disengage from the shank.

20. A fishing knife as claimed in claim 16, wherein the blade release comprises a turn-knob extending longitudinally from the rear end of the handle assembly through the handle core; and
wherein turning the turn-knob engages the turn-knob and the latching arm, causing the latching arm to disengage from the shank.
